(19) United States
(12) Patent Application Publication
(10) Pub. No.: US 2009/0276376 A1
(43) Pub. Date: Nov. 5, 2009

(54) Diminished value represented as a percentage or decimal equivalent in the field of automobiles

(75) Inventors: Jan van der Baan, Smithtown, NY (US); Allen Lipp, Oceanside, NY (US); Ryan Michael Hiller, Ownings Mills, MD (US)

Correspondence Address: RYAN HILLER, 2210 SHADED BROOK DRIVE, OWNINGS MILLS, MD, 21117, US

(73) Assignee: The Diminished Value Guide, LLC, Smithtown, NY (US)

(21) Appl. No.: 12/387,050

(22) Filed: Apr. 27, 2009

Related U.S. Application Data
(60) Provisional application No. 61/071,382, filed on Apr. 25, 2008.

(51) Int. Cl. G06Q 10/00; G06Q 50/00

(52) U.S. Cl. 705/400

(57) ABSTRACT

The purpose of this patent application is to secure the exclusive right for the expression of diminished value represented as a percentage or decimal equivalent. In the field of automotive valuation there is no way to provide equality between wholesale & retail automobile markets & conflicting values—other than using percentage or decimal equivalent.

At the time of this application, there is currently no standardized or truly interchangeable format in which diminished value may be calculated—especially one in which value of diminishment may be calculated using any and all existing wholesale or retail vehicle value sources.

This invention will provide consumer protection from any automobile industry professional when their automobile is involved in an incident that would reduce the value of a vehicle. It will also allow for the general public to have access to the same information as any industry professional needing to determine diminished value.

### CROSS REFERENCE TO RELATED APPLICATIONS

We have previously submitted a provisional patent application, No. 61/071.382 on Apr. 25, 2008. We have conducted our own search of the USPTO website, and not found any patents that were similar to the topics or claims in our application.

### FEDERALLY SPONSORED RESEARCH/DEVELOPMENT

Not Applicable

### SEQUENCE LISTING

Not Applicable

### BACKGROUND OF THE INVENTION

This invention applies to the field of automobiles in regards to diminished value. Diminished value is defined as the amount of lost monetary value due to a negative occurrence in the history of an automobile.

During the development of “The Diminished Value Guide”, it became apparent that there was no way to provide equality between wholesale & retail automobile markets & conflicting values—other than using percentage or decimal equivalent in establishing diminished value.

Typically, diminished value is calculated by automobile appraisers, banks & leasing companies, rental car companies and attorneys. It is also calculated by automobile dealers at time of vehicle trade-in. Diminished value is reluctantly calculated by insurance companies—and if done, it is not without a fight. The calculation of diminished value is not a standardized process and is crudely determined by a system of “best guess”. At the time of this application, there is currently no standardized or truly interchangeable format in which diminished value may be calculated—especially one in which value of diminishment may be calculated using any and all existing wholesale or retail vehicle value sources.

This invention will provide for consumer protection from any automobile industry professional when their automobile is involved in an accident or other negative event where sustained damage has occurred. It will also allow for the general public to have access to the same information as any industry professional needing to determine diminished value.

### SUMMARY OF THE INVENTION

This invention is designed as the authoritative reference/supplemental guide to help the average consumer and industry professional apply a percentage value adjustment (or decimal equivalent) of diminishment to an automobile with a negative history, previous damage, etc. that has been repaired to industry safety and quality standards.

This invention is designed as an intellectual property reported as percentages or decimal equivalent & generated by a computer program. This guide may also be available in book format. The goal is to address motor vehicle value adjustments based on existing vehicle value guides already in use. The guide is designed as a supplement to any existing wholesale or retail value source.

### BRIEF DESCRIPTION OF DRAWINGS

FIG. 1—Diminished value guide book publication “Instructions for use”.

FIG. 2—Diminished value guide book publication “Instructions for use” (continued).

FIG. 3—Diminished value guide book publication “Damage Categories”

FIG. 4—Diminished value guide book publication “Vehicle Configuration Page”

FIG. 5—Diminished value guide website homepage.

FIG. 6—Diminished value guide website “Login” Page.

FIG. 7—Diminished value guide website “Vehicle Configuration Page”.

FIG. 8—Diminished value guide website completed “Vehicle Configuration Page”.

FIG. 9—Diminished value guide website “Damage Categories” Page.

FIG. 10—Diminished value guide website “Price Guide Value” Page.

FIG. 11—Diminished value guide website “Summary” Page.

FIG. 12—Diminished value guide website “Administrator Diminished Value Percentage Adjustment” Page.

### DETAILED DESCRIPTION OF THE INVENTION

It is often the case that the general public is taken advantage of by corporate America. One example that may be cited is in the case of an automobile accident. If someone is involved in an automobile accident that is not their fault, they will have claims against the insured's insurance company. Usually, there are 2 such claims—“medical” and “collision damage”. The “medical claim” is used to pay for medical expenses if the victim has sustained an injury or needs to be examined. The “collision damage claim” is used to repair the damage to the vehicle. However, there is a little known claim that will also apply to this example—the “diminished value claim”. Diminished value is not a commonly known term to the average person. However, it does exist and can be easily defined as the amount of lost monetary value due to a negative occurrence in the history of an automobile. This means that even though the insurance company paid to have your car repaired, the fact of the matter is that it had sustained damage and been repaired and is now worth less money than as if the accident or negative occurrence had never happened in the first place. How much less is the car worth? That depends on several factors—including, but not limited to year, make, model, mileage, and the ability of vehicle to retain value in the marketplace. The first sentence of this paragraph stated that “It is often the case that the general public is taken advantage of by corporate America”. The proof of that statement in this example is that if this scenario were to actually take place, the insurance company would offer to open a “medical claim”, and also a “collision damage claim”. They would NOT offer to open a “diminished value claim”. If you happen to be lucky enough to know what diminished value is, you have to request—or demand that a diminished value claim be opened for your vehicle. Even if you submit such a request, the typical answer that you will hear is “no”, “that doesn't apply to this situation”, or “we don't do that”. Unfortunately, without hiring an attorney in these situations, the average person does not make any progress in this area Why? THIS IS THE INFORMATION THAT THE INSURANCE COMPANIES DON'T WANT YOU TO KNOW ABOUT.

What is the solution to this ongoing problem? The solution is to create a standardized system of determining diminished value accessible to everyone that will work for everyone. What does this mean? Well, the answer is simple. If diminished value was expressed in a percentage form or decimal equivalent, it could be used by anyone with access to any vehicle value source. This means that there would be common information shared between the general public and anyone involved in the automobile industry. This would effectively level the playing field for diminished value claims throughout the entire country.

How does this work? There would be a common three step processes executed by each party involved—the victim and the insurance company.

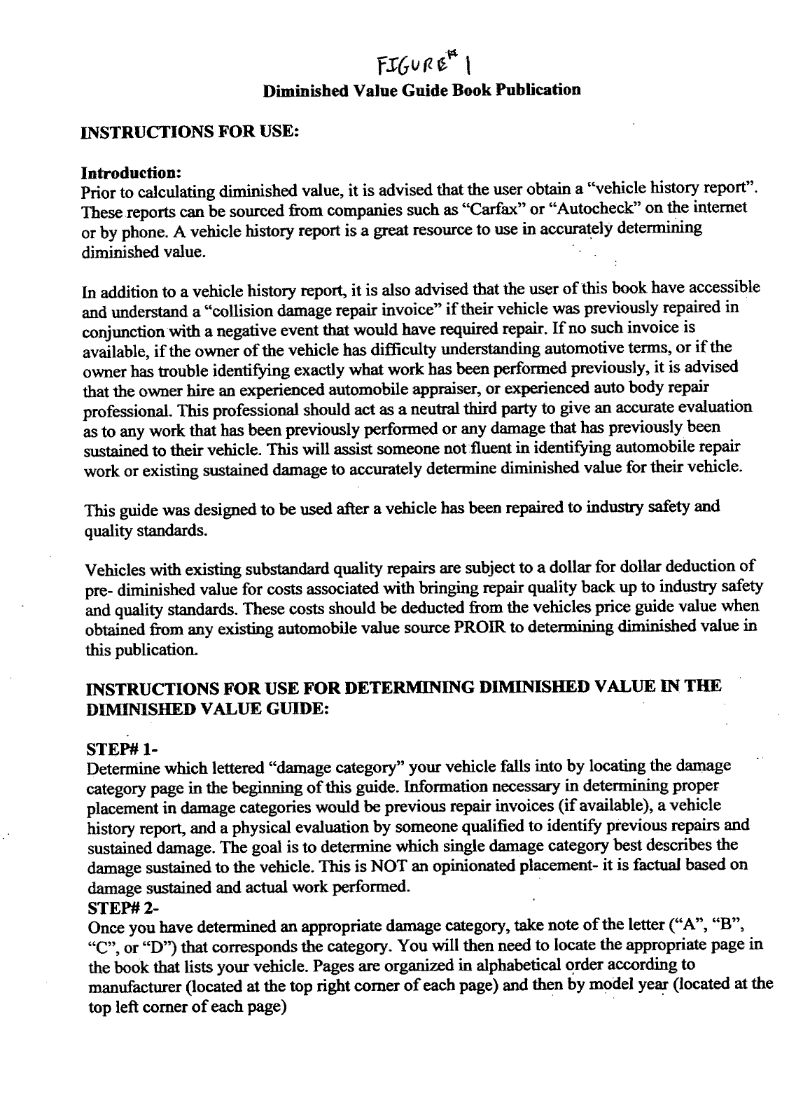

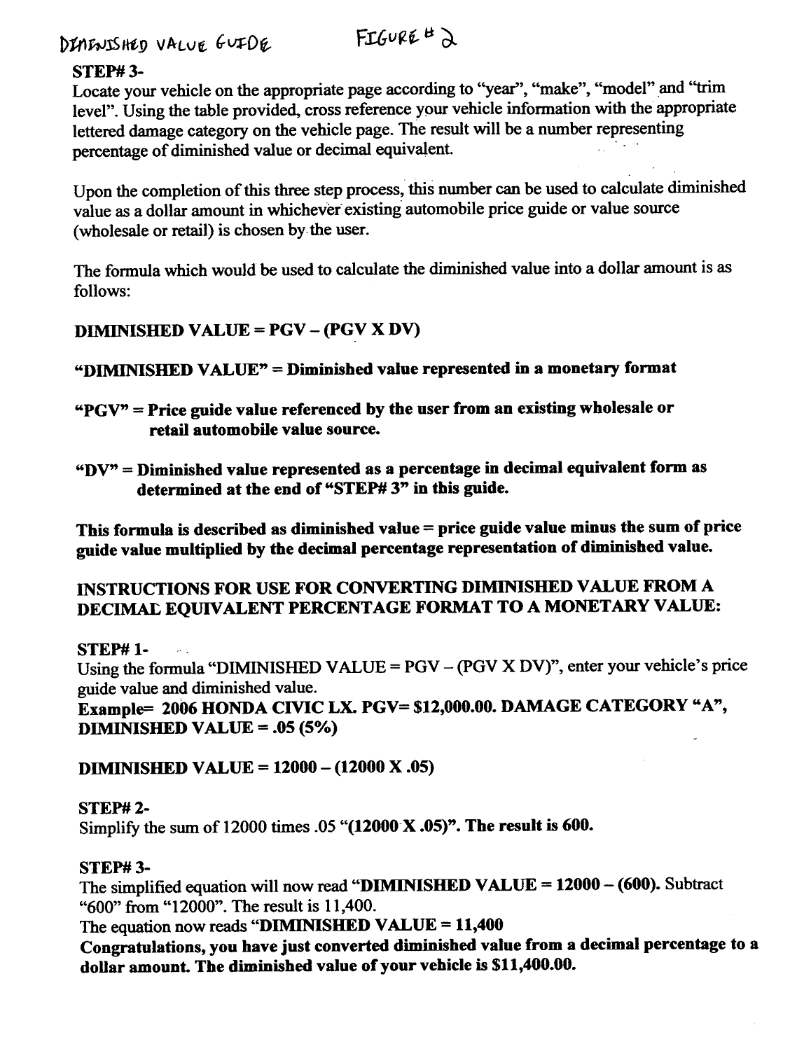

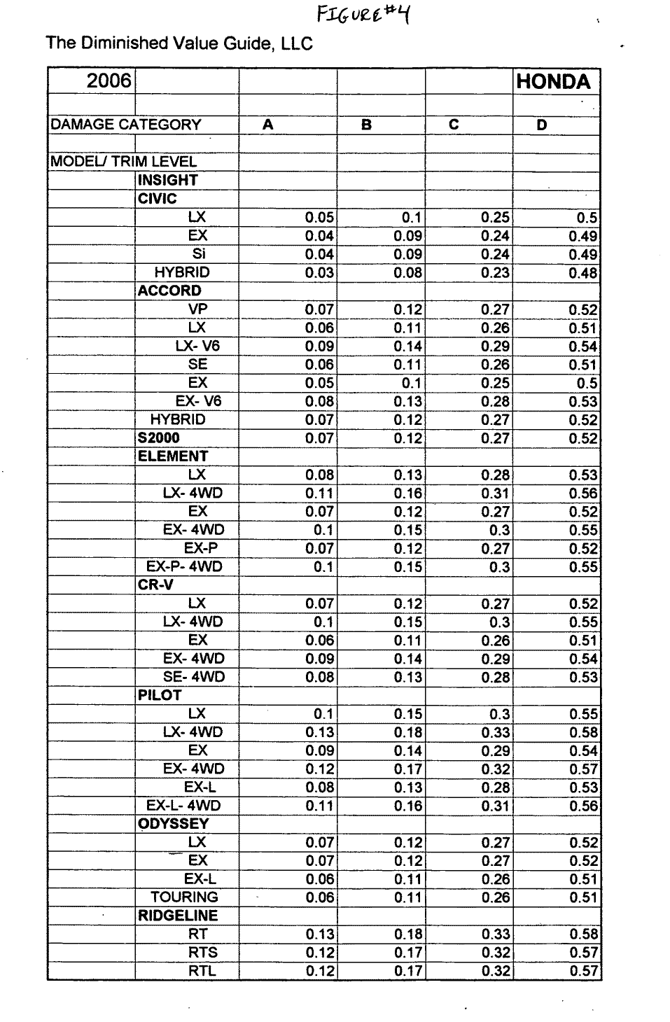

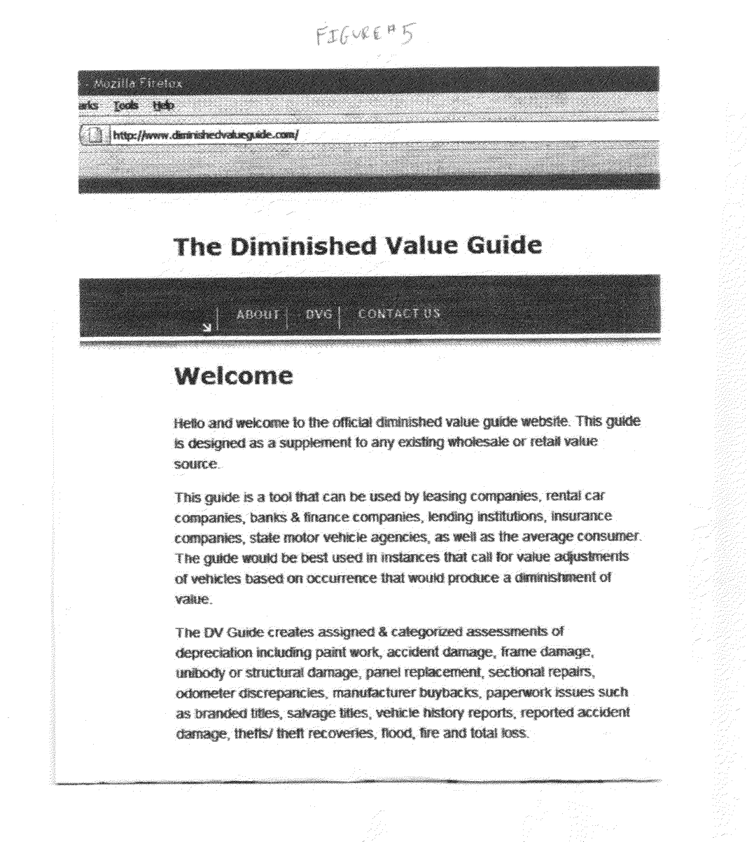

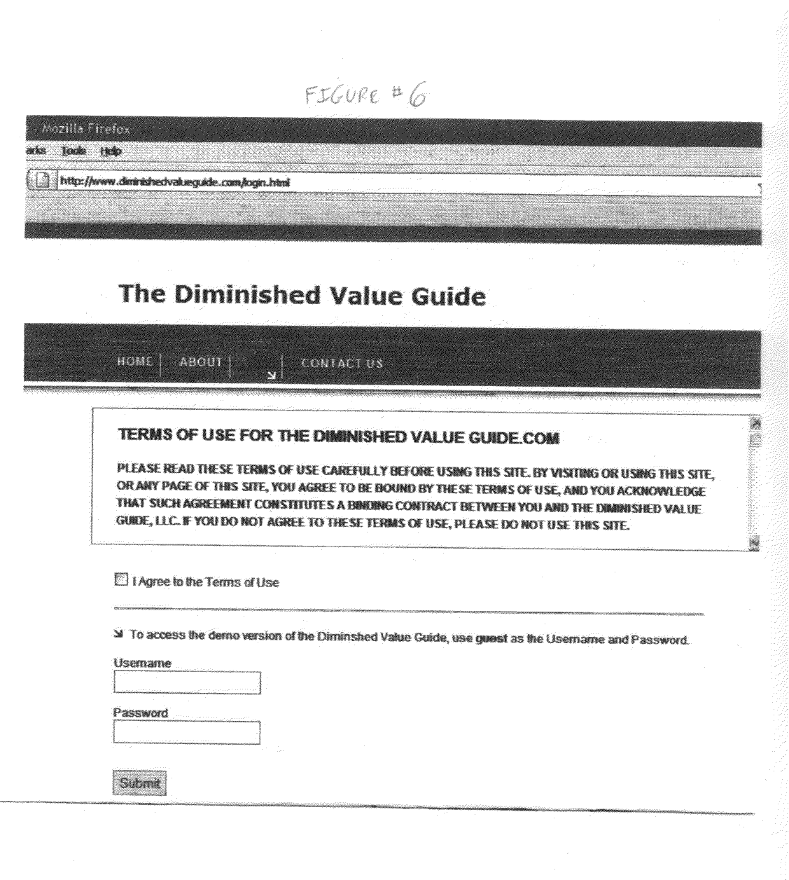

(USING THE BOOK FORMAT) Refer to FIGS. 1-4: The book format demonstrates how expressing diminished value in a percentage or decimal equivalent format creates a useful, concrete & tangible result.

STEP #1—Once the collision damage has been repaired, each party would refer to the collision damage repair invoice from the body shop for work performed on the vehicle over the course of repair.

STEP#2—Each party would then determine which single damage category best describes the damage sustained to the vehicle. This is NOT an opinionated placement—it is factual based on damage sustained and actual work performed.

STEP#3—Each party would then cross reference the appropriate damage category with the year, make, model & trim level of the vehicle that was damaged. This will yield a result in the form of a percentage value adjustment (or decimal equivalent) as “diminished value”.

As of the completion of this three step process, both the victim and the insurance company now have the same number—a common numerical value expressed in percent or decimal equivalent format that can be used to calculate diminished value as a dollar amount in whichever price guide or value source they choose to utilize.

The formula which would be used to calculate the dollar amount is as follows:

DIMINISHED VALUE=PGV−(PGV×DV)

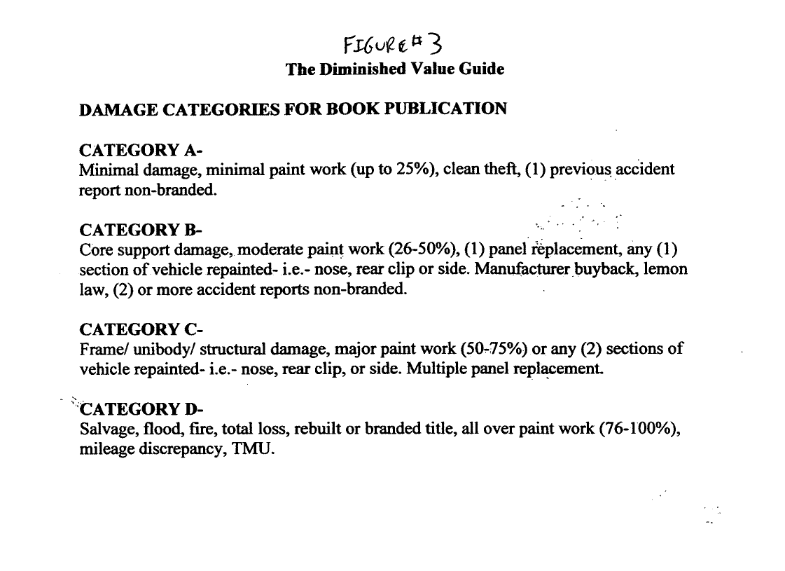

Referring to FIG. 2 will give a full explanation of this formula as well as how to use it.

Another method of calculating diminished value is through the use of our website program at www.diminishedvalueguide.com.

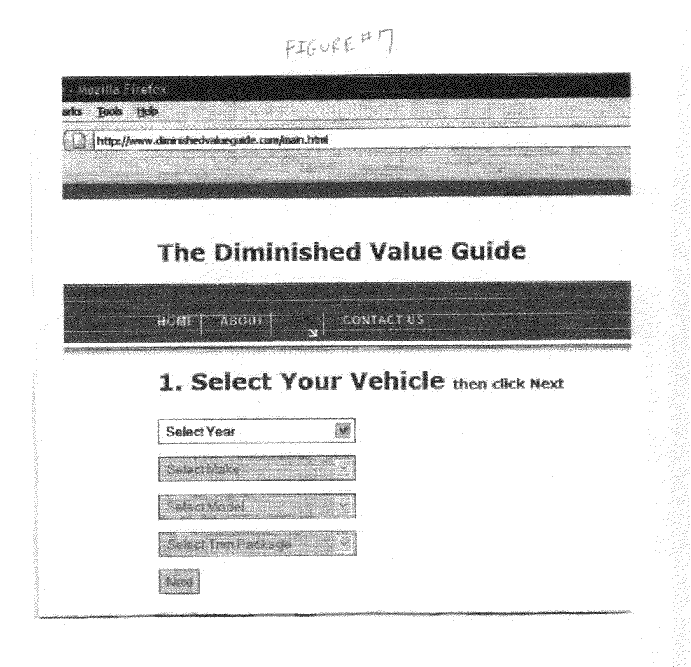

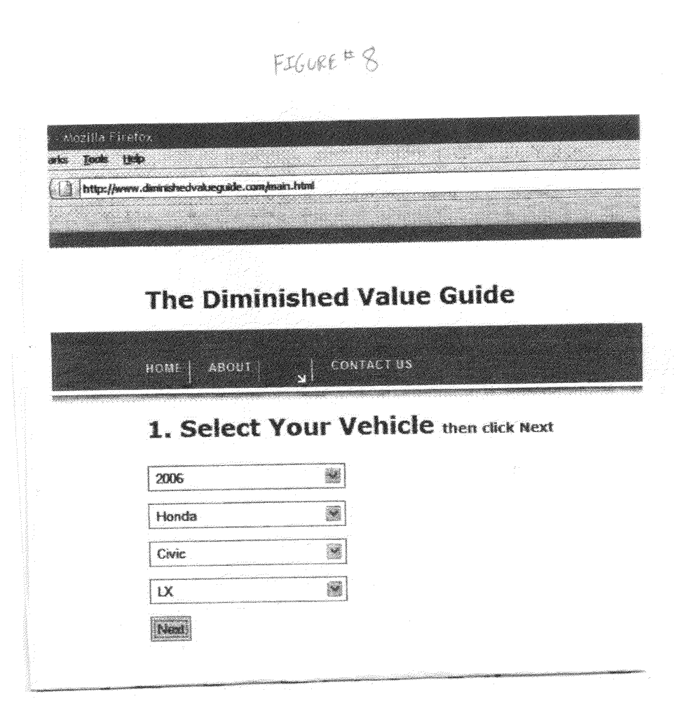

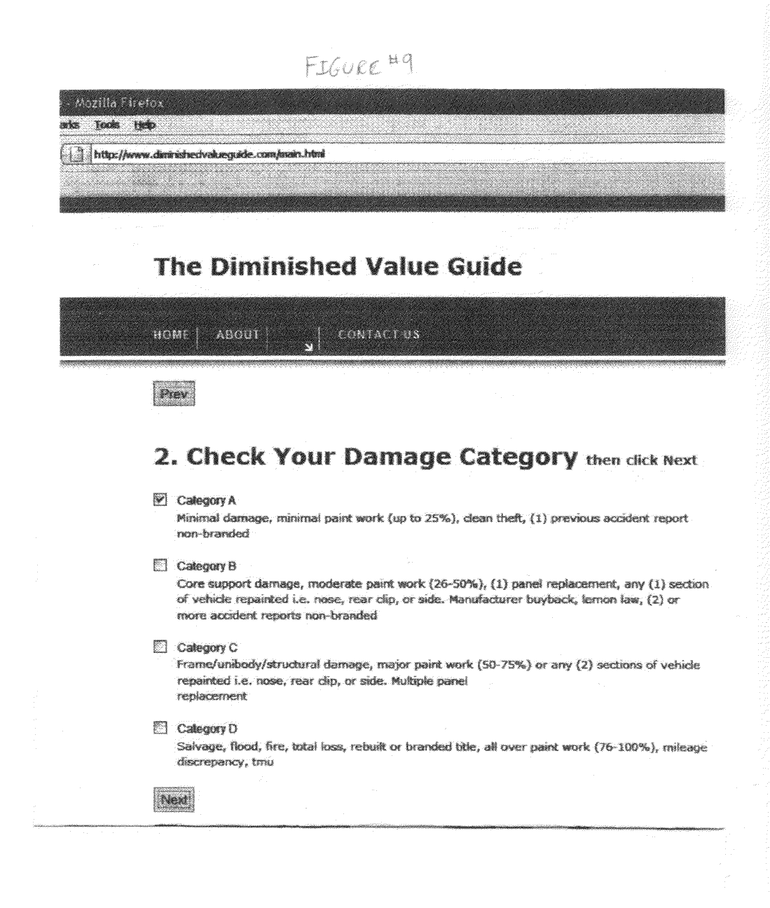

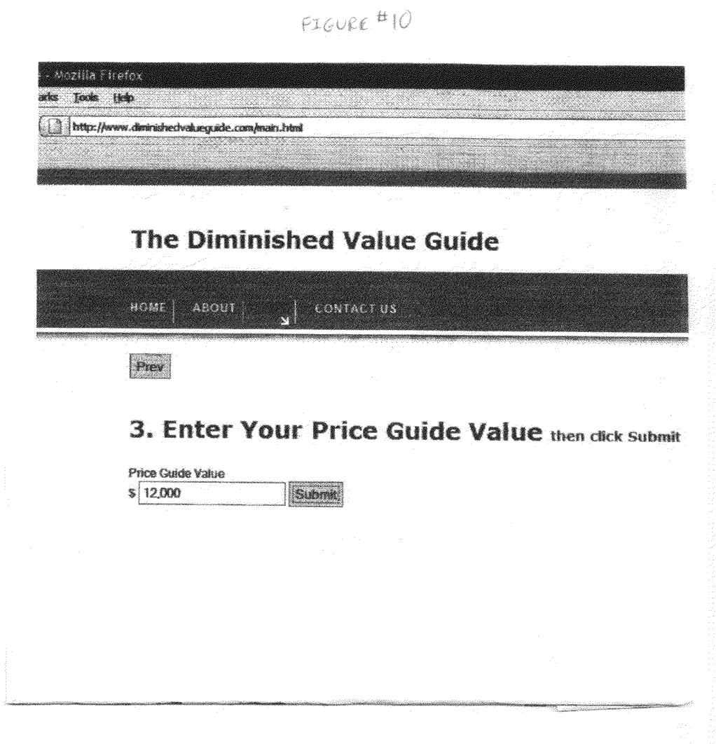

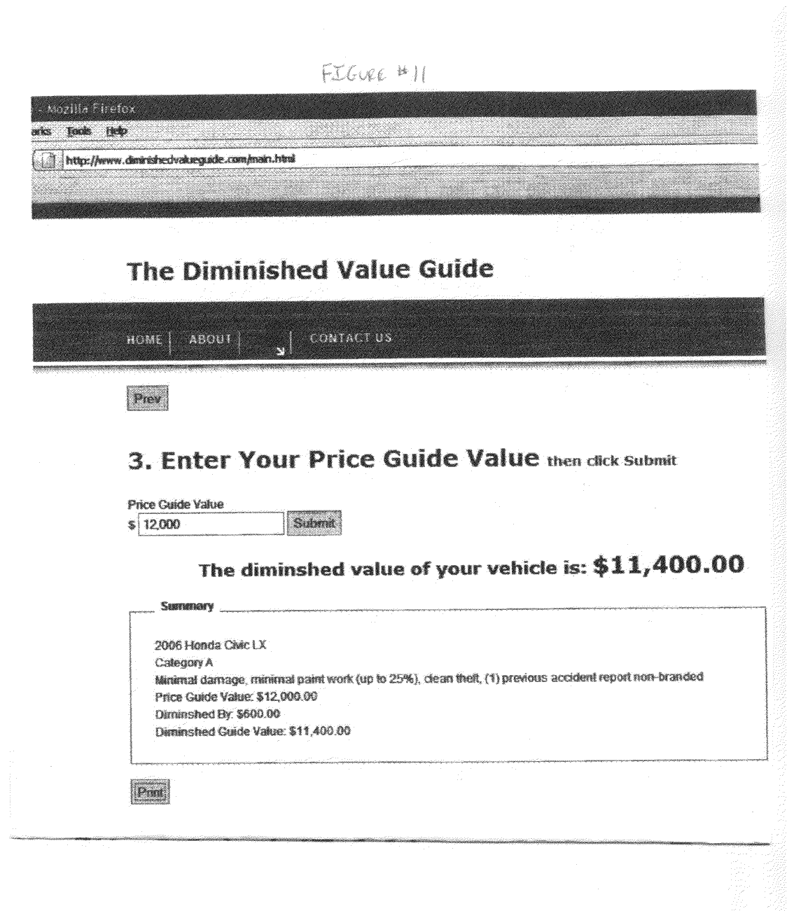

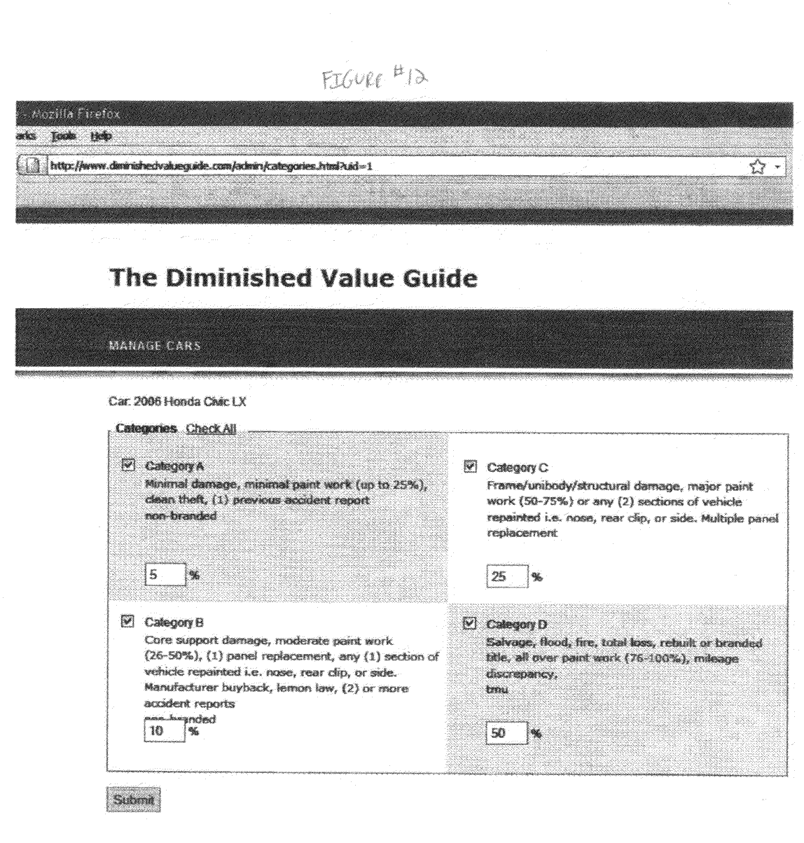

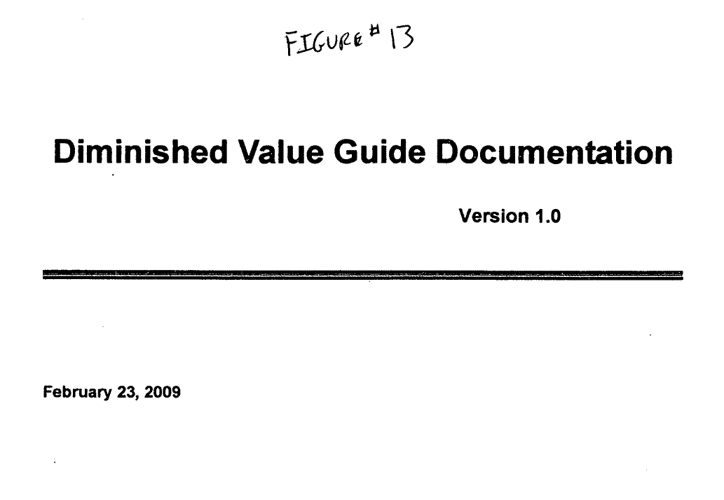

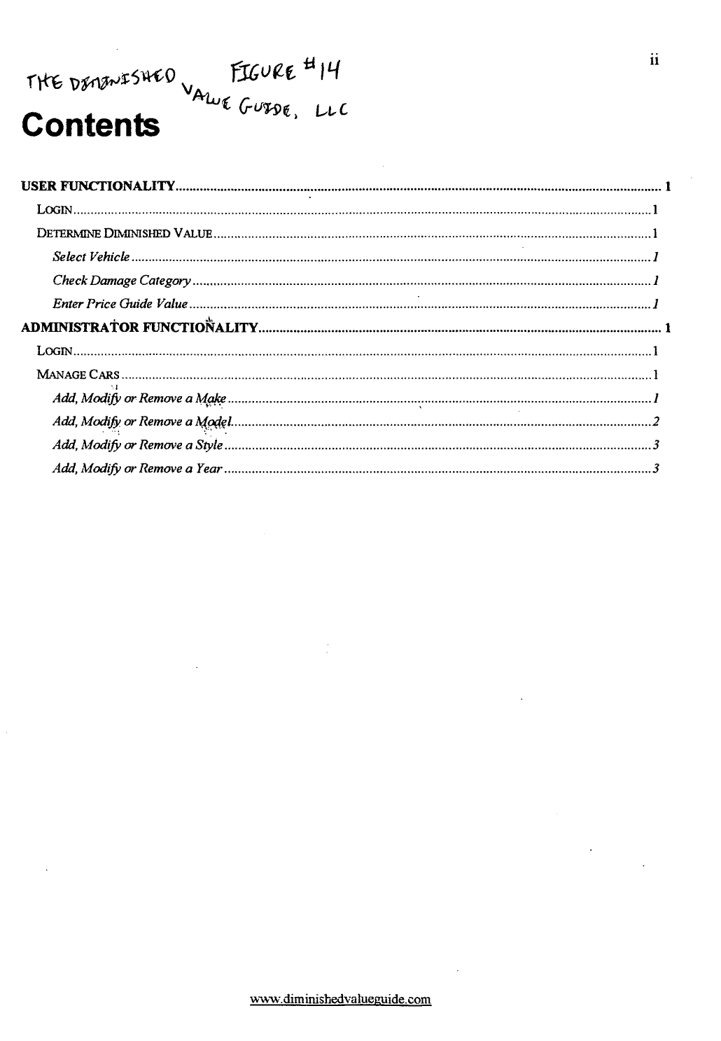

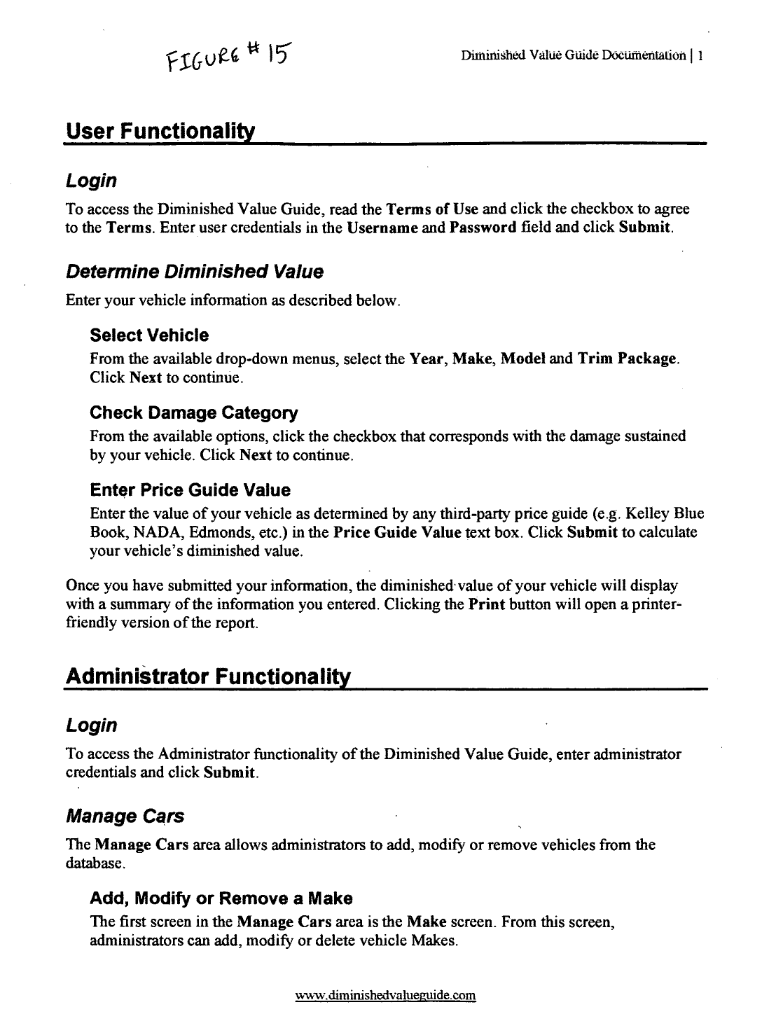

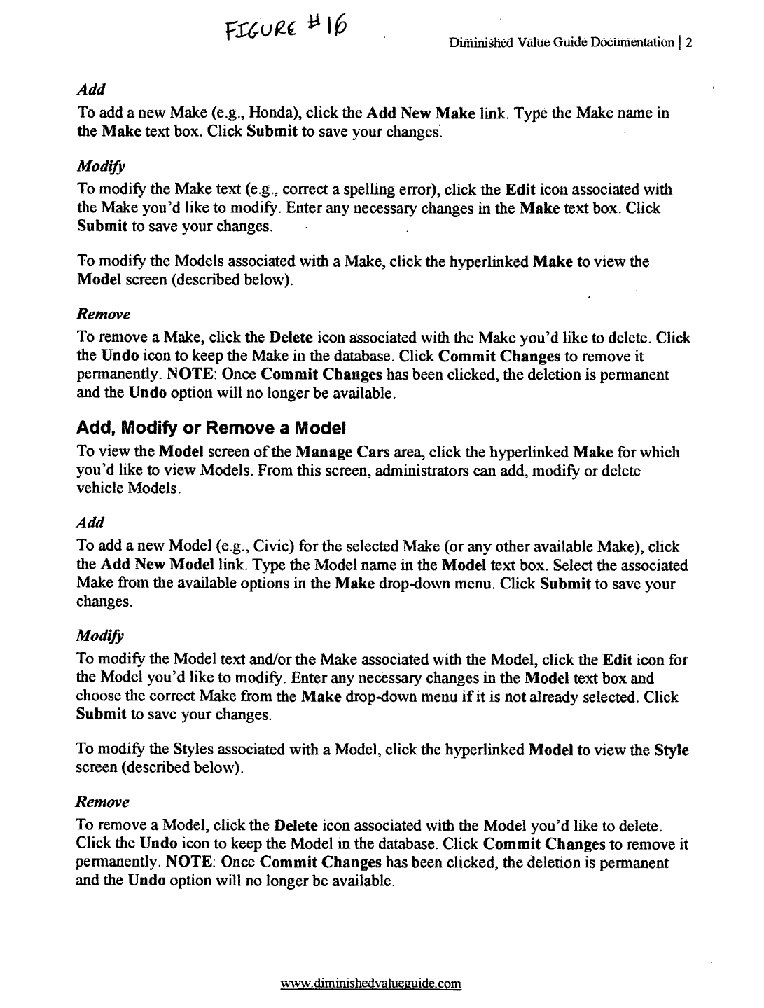

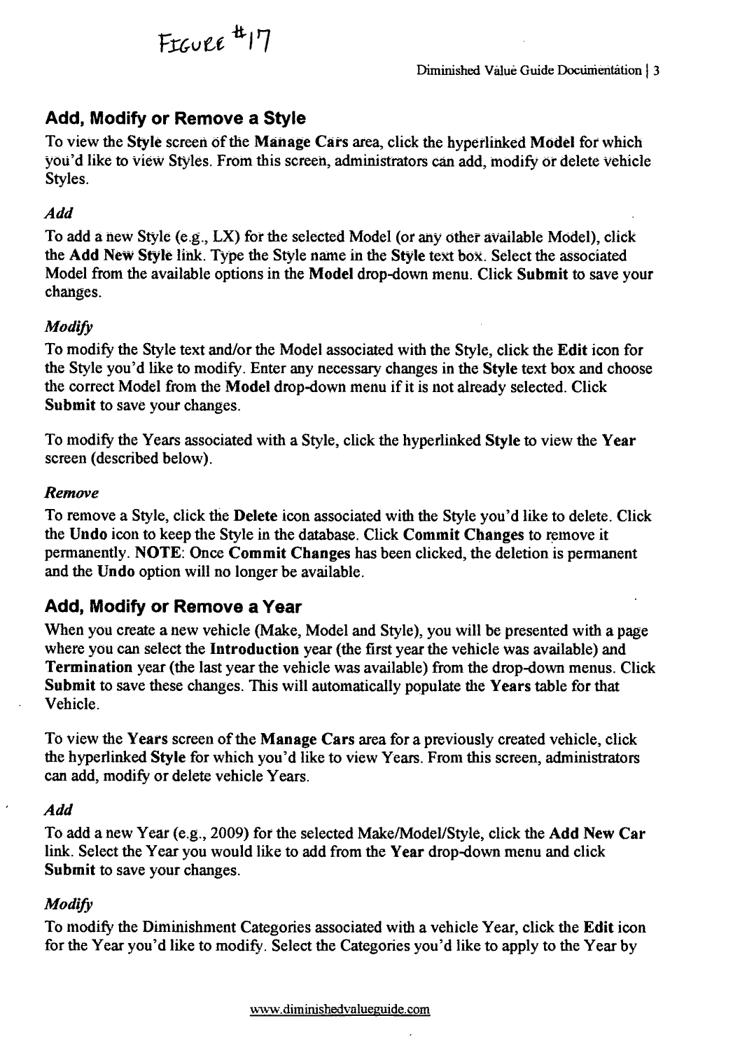

FIGS. 5-11 are snapshots of the actual computer website program pages that demonstrate how expressing diminished value in a percentage or decimal equivalent format creates a useful, concrete & tangible result. Refer to FIGS. 13-18 for detailed explanations of how the computer program works—step by step to explain FIGS. 5-11.

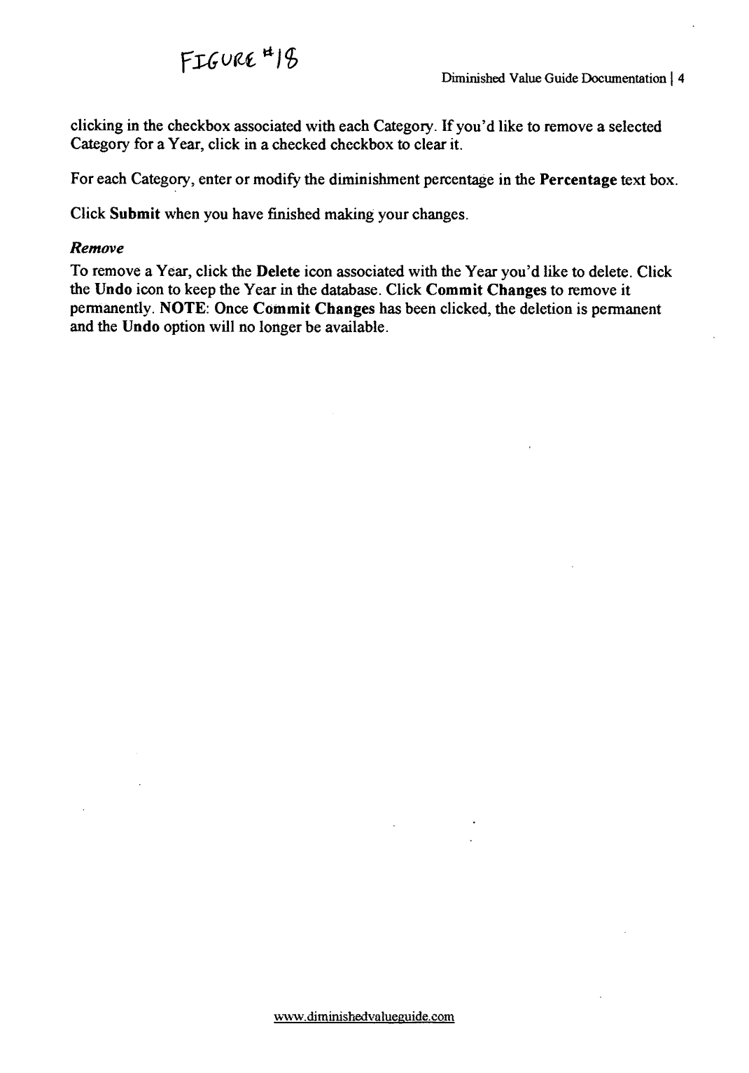

FIG. 12 shows the administrative side of how the percentage values are entered into the website program. Percentage values are calculated using a proprietary process.

Diminished value is calculated inside the website program using the following formula:

DV=PGV−(PGV×(DCP/100))

DV=DIMINISHED VALUE, PGV=PRICE GUIDE VALUE AND DCP=DIMINISHMENT CATEGORY PERCENTAGE.

The diminished value of the car is converted into monetary form by:

PGV−DV

Without a standardized system, the scenario would play out a little differently. The attorney hired by the victim would attempt to negotiate back and forth with the insurance company. As the attorney could possibly be someone experienced in auto accident claims, they might not be an expert in automobile values. This would mean one of two things—either the attorney would reference an automotive retail value source such as “NADA” or “KELLEY BLUE BOOK”, or they would hire an independent automobile appraiser to perform a vehicle evaluation. If we go with choice #1, the retail value source, the attorney would simply look up the vehicle's value, place it according to condition in a category, and “guess” as to how much money to try to get from the insurance company for depreciation. Choice #2 would involve the attorney's independent appraiser to evaluate the vehicle and then, using whatever experience they may have in the automobile industry to put an “official guess” or an “educated guess” as to what their experience believes the diminished value to be. At the same time, the insurance company is playing a game of their own. The insurance company wants to give the victim the least amount of money possible for the diminished value claim. The insurance company will evaluate the independent appraisal submitted by the attorney in hopes to discredit any part of it. The insurance company may also look at the appraiser's credentials to possibly discredit them as inexperienced or uneducated in the area of vehicle values. The insurance companies generally have large databases with information that they refuse to disclose a.k.a. “Proprietary Information” on other previous accidents involving collision damage, total loss data, wholesale value sources such as “BLACK BOOK”, previous diminished value payouts as well as other market statistics that they have compiled from doing business as such large companies. From this data, they will use either their company computer software or confidential corporate formulas to calculate how much they believe the amount of diminishment should be. THESE PROCESSES AMOUNT TO NOTHING BUT A GIANT GRAY AREA FOR THE VICTIM & EVERYONE INVOLVED. This is primarily how the lack of consumer protection by state and federal laws & regulations translates into the general public being at a strong disadvantage to the corporations—in this example—“insurance companies”. The only true way to determine diminished value is to make sure that everyone involved uses the same information, executes the same processes and debates ONLY which value source to use in determining the book value of the car—wholesale or retail—as the amount of diminishment stays the same in a percentage or decimal equivalent format.

It has already been established in real world situations and mentioned in the beginning of this application that diminished value is defined as “the amount of lost monetary value due to a negative occurrence in the history of an automobile”. That said, it is not assumed that when an automobile is involved in an accident or another type of negative event that the automobile is not worth as much money as prior to that event occurring in the first place—IT IS A FACT. This directly translates to a financial loss for whoever owns the vehicle. This example will also translate into financial loss for someone who is leasing or renting said vehicle. When the vehicle owner is renting or leasing said vehicle, they will be charged a penalty upon turning said vehicle back to the company they leased or rented it from. Usually, the renter or lessee would expect their insurance company to cover the charges. However, if the diminished value claim was not filed for or not handled properly in the first place, that person would be liable to pay thousands of dollars in damages due to the “diminished value” of the vehicle. How much would they be liable for? Again, there is currently no industry standard. That means that the leasing company or rental car firm (whichever would apply) would each have their own method and opinion for determining diminished value, the persons insurance company (if they even accepted any sort of responsibility for their client) would have their own method and opinion for determining diminished value, the person involved in the loss may hire an attorney who may have their own method and opinion for determining diminished value, that attorney may hire an automobile appraiser who may have their own method and opinion for determining diminished value, and before long—there would be 4 different opinions and methods for determining diminished value, Instead, the entire process could have been simplified by using a standardized format expressed in percentage or decimal form to eliminate all of the variables and factors open to interpretation associated with determining diminished value.

1- We claim the ability to express diminished value in percentage or decimal equivalent format.

2- Diminished value may then be used in a mathematical formula to determine the revised monetary value of an automobile.

3- The use of percentage value or decimal equivalent format allows diminished value to be converted into a monetary form of diminished value in any existing wholesale or retail automobile value source.

4- The use of diminished value in the form of percentage or decimal equivalent will allow the general public use of and access to the same information as industry professionals.
